(19) United States
(12) Patent Application Publication
(10) Pub. No.: US 2010/0266489 A1
(43) Pub. Date: Oct. 21, 2010

(54) REMOVAL OF FOREIGN METALS FROM INORGANIC SILANES

(75) Inventors: Hartwig Rauleder, Rheinfelden (DE); Ekkehard Mueh, Rheinfelden (DE); Jaroslaw Monkiewicz, Rheinfelden (DE); Hans Juergen Hoene, Bad Nauheim (DE); Raymund Sonnenschein, Frankfurt am Main (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/738,246

(22) PCT Filed: Aug. 20, 2008
(86) PCT No.: PCT/EP2008/060863

§ 371 Date: Jun. 9, 2010

(30) Foreign Application Priority Data
Oct. 20, 2007 (DE) 10 2007 050 199.6

(51) Int. Cl. C01B 33/107; C01B 39/02; C08J 5/20; C01B 33/20; C01B 31/08; B01J 20/10; C07F 7/08

(52) U.S. Cl. 423/700; 423/342; 521/25; 423/326; 423/445 R; 502/407; 556/487

(57) ABSTRACT

The invention relates to a method for the treatment of a composition containing inorganic silanes and at least one foreign metal and/or a compound containing a foreign metal, wherein the composition is brought in contact with at least one adsorption agent, and for obtaining the composition, in which the content of foreign metal and/or of a compound containing a foreign metal is reduced, and to a corresponding composition having a reduced foreign metal content, and further to the use of organic resins, activated carbons, silicates, and/or zeolites for the reduction of foreign metals and/or compounds containing foreign metals in compositions of inorganic silanes.

The invention relates to a process for treating a composition containing inorganic silanes and at least one extraneous metal and/or a compound containing extraneous metal, where the composition is contacted with at least one adsorbent and obtaining the composition in which the content of extraneous metal and/or the compound containing extraneous metal is reduced, and to a corresponding composition with a reduced extraneous metal content, and also to the use of organic resins, activated carbons, silicates and/or zeolites for reducing the level of extraneous metals and/or compounds containing extraneous metal in compositions of inorganic silanes.

Silicon compounds used in microelectronics, for example for producing high-purity silicon by means of epitaxy, or silicon nitride (SiN), silicon oxide (SiO), silicon oxynitride (SiON), silicon oxycarbide (SiOC) or silicon carbide (SiC), have to satisfy particularly high demands on the purity thereof. This is the case especially for the production of thin layers of these materials. In chip production, contamination of the silicon compounds with metallic impurities leads to undesired doping of the epitaxial layers, for example epitaxial silicon layers.

For example, uses of silicon tetrachloride (SiCl₄) include production of light waveguides. For these applications, SiCl₄ in very high purity is required. More particularly, metallic and/or metal-based impurities are a crucial disadvantage, even if they are present only in the region of the detection limit or in amounts of a few μg/kg (=ppb). Metallic impurities in halosilanes have an adverse effect on the damping behavior of light waveguides, by increasing the damping values and hence reducing the signal transmission.

In addition, high-purity HSiCl₃ is an important feedstock in the production of solar silicon. In general, halosilanes and/or hydrohalosilanes of high purity are sought-after starting compounds in the fields of electronics, of the semiconductor industry and in the pharmaceutical industry.

As a result of the production process for, for example, tetrachlorosilane from silicon, the impurities present in the silicon are usually likewise chlorinated and some of them are entrained into the subsequent synthesis steps. Especially these chlorinated metallic impurities have an adverse effect in the production of components in the field of electronics.

EP 0 684 245 A2 discloses reducing the content of hydrocarbons in halosilanes by adsorbing them on an adsorbent.

It was an object of the present invention to provide a process for reducing the extraneous metal content and/or the content of a compound containing extraneous metal in inorganic silanes. In addition, the process should be inexpensive and simple to manage. It was a further object to provide inorganic silanes with a very low extraneous metal content and/or very low content of compounds containing extraneous metal.

The objects are achieved according to the information in the claims.

It has been found that, surprisingly, by treating a composition comprising inorganic silanes and at least one extraneous metal and/or a compound containing extraneous metal, by contacting with at least one adsorbent, especially a dry adsorbent, and obtaining the composition, the content of the extraneous metal and/or of the compound containing extraneous metal is reduced significantly.

The invention therefore provides a process for treating a composition containing inorganic silanes and at least one extraneous metal and/or a compound containing extraneous metal, wherein the composition is contacted with at least one adsorbent, especially a dry adsorbent, and a composition whose content of extraneous metal and/or at least one compound containing extraneous metal has been reduced is obtained. It is particularly advantageous that the extraneous metal content and/or the content of the compound containing extraneous metal—generally a residual content of extraneous metal or compound containing extraneous metal which is difficult to remove by distillation or cannot be removed any further—can especially be reduced independently, in each case to a content in the region of less than 100 μg/kg, especially less than 25 μg/kg, preferably less than 15 μg/kg, more preferably less than 10 μg/kg.

The extraneous metals and/or the compounds containing extraneous metal can generally be determined by quantitative analysis methods as known per se to those skilled in the art, for example by means of atomic absorption spectroscopy (AAS) or photometry, especially by inductively coupled plasma mass spectrometry (ICP-MS) and inductively coupled plasma optical emission spectrometry (ICP-OES)—to mention just a few options.

Inorganic silanes are understood to mean especially halosilanes, hydrohalosilanes, halosilanes substituted by at least one organic radical and/or hydrohalosilanes substituted by at least one organic radical, and also mixtures of these silanes. In one embodiment, pure hydrosilanes may also be included. In the halogen-containing inorganic silanes, each halogen may be selected independently of further halogen atoms from the group of fluorine, chlorine, bromine and iodine, such that, for example, it is also possible for mixed halosilanes such as SiBrCl₂F or SiBr₂ClF to be present.

The inorganic silanes preferably include the chlorine-substituted, predominantly monomeric silanes, for example tetrachlorosilane, trichlorosilane, dichlorosilane, monochlorosilane, methyltrichlorosilane, trichloromethylsilane, trimethylchlorosilane, dimethyldichlorosilane, phenylmethyldichlorosilane, phenyltrichlorosilane, vinyl-trichlorosilane, dihydrodichlorosilane. However, the extraneous metal content of the monomeric silanes, such as tetramethylsilane, trimethylsilane, dimethylsilane, methylsilane, monosilane or organohydrosilanes, or else disilane, trisilane, tetrasilane and/or pentasilane and higher homologous silanes, can also be reduced by the process according to the invention. In addition to these preferred, predominantly monomeric compounds, it is, however, also possible to correspondingly reduce the extraneous metal content of further dimeric compounds, such as hexachlorodisilane, oligomeric compounds, such as octachlorotrisilane, decachlorotetrasilane, and higher homologous halopolysilanes, and mixed-hydrogenation halogenated polysilanes, for example pentachlorohydrodisilane or tetrachlorodihydrodisilane, and mixtures thereof with monomeric, linear, branched and/or cyclic oligomeric and/or polymeric inorganic silanes. The cyclic oligomeric compounds include compounds of the SiₙX₂ₙ type where n>3, such as Si₅Cl₁₀, and the polymeric inorganic compounds include, for example, halopolysilanes, i.e. polysilicon halides SiₙX₂ₙ₊₂ where n≧5 and/or polysilicon hydrohalides SiₙHₐX_{[(2n+2)-a]} where n≧2 and 0≦a≦(2n+2), where X in each case is a halogen, such as F, Cl, Br, I, especially Cl.

Extraneous metals and/or compounds containing extraneous metal are considered to be those in which the metal does not correspond to silicon. In particular, the at least one extraneous metal and/or the at least one compound containing extraneous metal is/are adsorbed selectively from the composition containing inorganic silanes; the adsorption can be effected either in solution or in the gas phase in this case. Extraneous metals or compounds containing extraneous metals are also understood to mean semimetals or compounds containing semimetals, for example boron and boron trichloride.

The extraneous metals and/or compounds containing extraneous metal whose levels are to be reduced are especially metal halides, metal hydrohalides and/or metal hydrides and mixtures of these compounds. However, the metal halides, metal hydrohalides or metal hydrides functionalized with organic radicals such as alkyl or aryl groups can also be removed from inorganic silanes with very good results. Examples thereof may be aluminum trichloride or else iron(III) chloride, and also entrained particulate metals which may originate from continuous processes.

Preferably, the contents of boron, aluminum, potassium, lithium, sodium, magnesium, calcium and/or iron can be reduced; more particularly, compounds based on these metals are removed.

The process according to the invention is particularly suitable for the removal or reduction of the level of compounds which contain extraneous metal and whose boiling point is in the region of the boiling point of an inorganic silane, or would be distilled over with the latter as an azeotrope. Some of these compounds containing extraneous metal can be removed by distillation only with difficulty, or cannot be removed at all. The boiling point within the region of the boiling point of an inorganic silane compound is considered to be a boiling point within the range of ±20° C. of the boiling point of one of the inorganic silanes at standard pressure (about 1013.25 hPa or 1013.25 mbar).

In general, the level of the extraneous metal and/or the compound containing extraneous metal can be reduced by 50 to 99% by weight. The extraneous metal content is preferably reduced by 70 to 99% by weight, more preferably by 85 to 99% by weight. For iron-containing compositions, the process enables a reduction in the residual content by 95 to 99% by weight. In general, for example, the aluminum content of a composition of inorganic silanes can be reduced by 50 to 99% by weight, preferably by 85 to 99% by weight, and the boron content by at least 70% by weight, preferably by 95 to 99.5% by weight.

The extraneous metal content and/or the content of the compound containing extraneous metal in a composition can preferably be reduced in relation to the metallic compound, especially independently of one another, in each case to a content in the region of less than 100 μg/kg, especially of less than 25 μg/kg, preferably less than 15 μg/kg, more preferably 0.1 to 10 μg/kg, down to the particular detection limit.

To perform the process, it is appropriately possible to use either inorganic or organic adsorbents which may additionally be hydrophilic and/or hydrophobic. According to which extraneous metals or compounds containing extraneous metal are to be removed, it may be appropriate to use a mixture of hydrophilic and hydrophobic adsorbents, or else one adsorbent which has both functions. The adsorbents may be selected from the group of the organic resins, activated carbons, silicates, especially from silica gels, and/or zeolites. Preferred adsorbents are Amberlite™ XAD-4 resin from Röhm Haas, activated carbon, especially Norit activated carbon, montmorillonites, especially K 10 montmorillonite, zeolites such as Wessalith F 20, and also silica gels such as fumed silica or precipitated silica, especially Grace type 432 silica gel (extruded at 550° C.) or Aerosil® 200.

In general, the inventive treatment of compositions containing inorganic silanes is performed in such a way that the adsorbent is first carefully dried in order to prevent hydrolysis of the silanes to be purified. Subsequently, the dried adsorbent is contacted under protective gas atmosphere with the composition, optionally while stirring. The treatment is suitably effected at room temperature and standard pressure over several hours. The composition is typically contacted with the adsorbent for between 1 minute up to 10 hours, generally up to 5 hours. The purified composition is generally obtained or removed by filtration, centrifugation or sedimentation. As required, the process regime may be batchwise or continuous. The resulting composition based on inorganic silanes has an extraneous metal content and/or content of compound containing extraneous metal reduced by 50 to 99% by weight.

The invention likewise provides a process for treating a composition containing inorganic silanes and at least one extraneous metal and/or a compound containing extraneous metal, according to the above-described process, wherein at least one inorganic silane corresponds to the general formula I

SiₙHₐR_{b}X_{((2n+2)-a-b)} (I)

where 1≦n≦5, 0≦a≦12, 0≦b≦12 and each X in the silane is independently a halogen selected from the group of fluorine, chlorine, bromine and iodine, and each R group in the silane is independently a linear, branched and/or cyclic alkyl group having 1 to 16 carbon atoms, or an aryl group. Aryl groups should also be understood to mean alkyl-substituted aryls, with linear, branched or cyclic alkyl groups having 1 to 8 carbon atoms. More preferably, at least one silane corresponds to the general formula I where n=1, X=chlorine, 0≦a≦3, 0≦b≦3 and a+b≦3 and R to a linear, branched and/or cyclic alkyl group having 1 to 16 carbon atoms or an aryl group.

The particularly preferred inorganic silanes include the chlorine-substituted monomeric silanes where n=1 and X=Cl, for example tetrachlorosilane, trichlorosilane, trichloromethylsilane, trimethylchlorosilane, dimethyldichlorosilane, phenylmethyldichlorosilane, phenyltrichlorosilane, vinyltrichlorosilane, dihydro-dichlorosilane, dichlorosilane, monochlorosilane, methyltrichlorosilane.

The process is also preferentially suitable for treatment of compositions which contain compounds of the type of the general formula I

SiₙHₐR_{b}X_{((2n+2)-a-b)} (I)

where n=1, a=4 or 0≦a≦3, 0≦b≦3 and a +b 5 3, or dimeric compounds where n=2, 0≦a≦4, 0≦b≦4 and where each X in the silane is independently a halogen selected from the group of fluorine, chlorine, bromine and iodine, and each R group in the silane independently corresponds to a linear, branched and/or cyclic alkyl group having 1 to 16 carbon atoms or an aryl group. An aryl group is also understood to mean alkyl-substituted aryls, with linear, branched or cyclic alkyl groups having 1 to 8 carbon atoms. In trimeric linear compounds, n=3, 0≦a≦8, 0≦b≦8, where the substitution pattern of X and R may be as stated above. Correspondingly, the substitution pattern in tetrameric compounds is n=4, 0≦a≦10, 0≦b≦10, and in pentameric linear compounds n=5, 0≦a≦12, 0≦b≦12, where the substitution pattern of X and R may be as stated above, preference being given to the halogen-substituted compounds.

The extraneous metal content and/or the content of the compound containing extraneous metal in this composition may preferably, in relation to the metallic compound, especially independently, be reduced in each case to a content in the region of less than 100 μg/kg, especially of less than 25 μg/kg, preferably less than 15 μg/kg, more preferably less than 10 μg/kg.

To perform the process, the either organic or inorganic, hydrophilic and/or hydrophobic adsorbents already mentioned may be used.

The invention further relates to a composition containing at least one inorganic silane of the general formula I

SiₙHₐR_{b}X_{((2n+2)-a-b)} (I)

where 1≦n≦5, 0≦a≦12, 0≦b≦12 and each X in the silane is independently a halogen and each R group in the silane is independently a linear, branched and/or cyclic alkyl group having 1 to 16 carbon atoms or an aryl group, where the extraneous metal content and/or the content of the compound containing extraneous metal is especially in each case independently less than 100 μg/kg, especially less than 25 μg/kg, preferably less than 15 μg/kg, more preferably less than 10 μg/kg. The extraneous metals are especially boron, aluminum, iron, calcium, magnesium, potassium and/or lithium. Particularly preferred compositions contain at least one inorganic silane where n=1, X=chlorine, 0≦a≦3, 0≦b≦3 and a+b≦3, where R, especially independently, corresponds to a linear, branched and/or cyclic alkyl group having 1 to 16 carbon atoms or an aryl group.

The invention also provides for the use of an organic resin, of activated carbon, of a silicate, especially of a silica gel, and/or of a zeolite for reducing the content of at least one extraneous metal and/or at least one compound containing extraneous metal from compositions containing inorganic silanes of the general formula I

SiₙHₐR_{b}X_{((2n+2)-a-b)} (I)

where 1≦n≦5, 0≦a≦12, 0≦b≦12 and each X in the silane is independently a halogen and each R group in the silane is independently a linear, branched and/or cyclic alkyl group having 1 to 16 carbon atoms or an aryl group. The composition preferably contains an inorganic silane selected form the compounds of the general formula I where n=1, X=chlorine, 0≦a≦3, 0≦b≦3 and a+b≦3, where R independently corresponds to a linear, branched and/or cyclic alkyl group having 1 to 16 carbon atoms or to an aryl group.

The invention is illustrated in detail by the examples which follow.

### EXAMPLES

### Example 1.1

### Pretreatment of the Adsorbent

The adsorbents are dried carefully before use in the process in order to prevent hydrolysis of the silanes to be purified.

### Example 1.2

### General Process Method for Treatment of the Silane Contaminated with Extraneous Metals and/or Metallic Compounds

A defined amount of adsorbent is initially charged in a 500 ml stirred apparatus comprising a glass four-neck flask with condenser (water, dry ice), dropping funnel, stirrer, thermometer and nitrogen connection, and dried under reduced pressure (<1 mbar) at about 170° C. over 5 hours, then gradually aerated with dry nitrogen and cooled. Subsequently, 250 ml of the silane to be purified are added via the dropping funnel. Over a period of 5 hours, the adsorption operation is performed under standard pressure at room temperature under a protective gas atmosphere. The adsorbent is removed from the silane by drawing it through a frit (por. 4) into an evacuated 500 ml glass flask with venting apparatus. Subsequently, the glass flask is aerated with nitrogen and discharged into a nitrogen-purged Schott glass bottle.

### Example 1.3

The example which follows was carried out with the amounts specified here according to the general process method.

119.97 g of Amberlite™ XAD 4 were pretreated according to the general method as described in example 1.2, and 250 ml of trichlorosilane were added. The metal contents before and after the treatment were determined by means of ICP-MS.

TABLE 1.3
Extraneous metal contents before and after the treatment:

| Metal | Content before treatment | Content after treatment | |
|---|---|---|---|
| Aluminum | 130 μg/kg | 18 | μg/kg |
| Boron | 1100 μg/kg | <10 | μg/kg |
| Iron | 130 μg/kg | 6.0 | μg/kg |

### Example 1.4

The example which follows was carried out with the amounts specified here according to the general process method.

40.01 g of K 10 montmorillonite were pretreated as described in the general method under example 1.2, and 250 ml of trichlorosilane were added. The metal contents before and after the treatment were determined by means of ICP-MS.

TABLE 1.4
Extraneous metal contents before and after the treatment:

| Metal | Content before treatment | Content after treatment | |
|---|---|---|---|
| Aluminum | 130 μg/kg | <0.7 | μg/kg |
| Boron | 1100 μg/kg | <10 | μg/kg |
| Iron | 130 μg/kg | 3.3 | μg/kg |

### Example 1.5

The example which follows was carried out with the amounts specified here according to the general process method.

20.17 g of Wessalith F 20 were pretreated as described in the general method under example 1.2 and 250 ml of trichiorosilane were added. The metal contents before and after the treatment were determined by means of ICP-MS.

TABLE 1.5
Extraneous metal contents before and after the treatment:

| Metal | Content before treatment | Content after treatment | |
|---|---|---|---|
| Aluminum | 130 μg/kg | 66 | μg/kg |
| Boron | 1100 μg/kg | <10 | μg/kg |
| Iron | 130 μg/kg | 4.0 | μg/kg |

1. A process for treating a composition containing inorganic silanes and at least one extraneous metal and/or a compound containing extraneous metal,
wherein
the composition is contacted with at least one adsorbent and obtaining a composition in which the content of extraneous metal and/or the compound containing extraneous metal is reduced.

2. The process according to claim 1,
wherein
the inorganic silanes are selected from halosilanes, hydrohalosilanes, organohydrosilanes, hydrosilanes formed from halosilanes substituted by at least one organic radical and/or formed from hydrohalosilanes substituted by at least one organic radical and/or mixtures of these silanes.

3. The process according to claim 2,
wherein
the halogen is chlorine.

4. The process according to claim 1,
wherein
the inorganic silanes are in monomeric, dimeric, oligomeric and/or polymeric form.

5. The process according to claim 1,
wherein
the compound containing extraneous metal is selected from metal halides, metal hydrides, metal halides substituted by organic radicals and/or metal hydrides substituted by organic radicals.

6. The process according to claim 1,
wherein
the boiling point of the compound containing extraneous metal is in the range of ±20° C. of the boiling point of an inorganic silane at standard pressure.

7. The process according to claim 1,
wherein
the extraneous metal and/or the compound containing extraneous metal comprises boron, aluminum, sodium, potassium, lithium, magnesium, calcium and/or iron.

8. The process according to claim 1,
wherein
the content of the extraneous metal and/or of the compound containing extraneous metal is reduced by 50 to 99% by weight.

9. The process according to claim 1,
wherein
the extraneous metal content and/or the content of the compound containing extraneous metal is reduced in each case to less than 100 μg/kg.

10. The process according to claim 1,
wherein
the adsorbent is hydrophilic and/or hydrophobic.

11. The process according to claim 1,
wherein
the adsorbent is selected from the group consisting of organic resins, activated carbons, silicates and/or zeolites.

12. The process according to claim 1,
wherein
the process is operated batchwise or continuously.

13. A process for treating a composition containing inorganic silanes and at least one extraneous metal and/or a compound containing extraneous metal according to claim 1,
wherein
at least one inorganic silane corresponds to the general formula I,
SiₙHₐR_{b}X_{((2n°2)-a-b)} (I)
in which 1≦n≦5, 0≦a≦12, 0≦b≦12 and each X in the silane is independently a halogen and each R group in the silane is independently a linear, branched and/or cyclic alkyl group having 1 to 16 carbon atoms or an aryl group.

14. The process according to claim 13,
wherein
the inorganic silane where n=1, X=chlorine, 0≦a≦3, 0≦b≦3 and a+b≦3 satisfies the general formula I,
SiₙHₐR_{b}X_{((2n+2)-a-b)} (I)
and R corresponds to a linear, branched and/or cyclic alkyl group having 1 to 16 carbon atoms or an aryl group.

15. The process according to claim 14,
wherein
the silane is monosilane, monochlorosilane, dichlorosilane, trichlorosilane, tetrachlorosilane, methyltrichlorosilane, dimethyldichlorosilane and/or trimethylchlorosilane.

16. A composition containing at least one inorganic silane of the general formula I
SiₙHₐR_{b}X_{((2n+2)-a-b)} (I)
where 1≦n≦5, 0≦a≦12, 0≦b≦12 and each X in the silane is independently a halogen and each R group in the silane is independently a linear, branched and/or cyclic alkyl group having 1 to 16 carbon atoms or an aryl group,
wherein
the extraneous metal content and/or the content of the compound containing extraneous metal is in each case less than 100 μg/kg.

17. The composition according to claim 16,
wherein
the inorganic silane where n=1, X=chlorine, 0≦a≦3, 0≦b≦3 and a +b <3 satisfies the general formula I,
SiₙHₐR_{b}X_{((2n+2)-a-b)} (I)
and R corresponds to a linear, branched and/or cyclic alkyl group having 1 to 16 carbon atoms or an aryl group.

18. The composition according to claim 16,
wherein
the extraneous metal content and/or content of the compound containing extraneous metal is in each case less than 25 μg/kg.

19. A composition for reducing the content of at least one extraneous metal and/or of at least one compound containing extraneous metal from compositions containing inorganic silanes comprising an organic resin, an activated carbon, a silicate and/or zeolite.

20. A method for reducing the content of at least one extraneous metal and/or at least one compound containing extraneous metal from compositions containing inorganic silanes comprising using an organic resin, an activated carbon, a silicate and/or zeolite.
